(19) United States
(12) Patent Application Publication
(10) Pub. No.: US 2026/0206030 A1
(43) Pub. Date: Jul. 16, 2026

(54) AMBIENT POWER DOWNLINK BANDWIDTH CONTROL

(71) Applicant: QUALCOMM Incorporated, San Diego, CA (US)

(72) Inventors: Stephen Jay SHELLHAMMER, Ramona, CA (US); Bin TIAN, San Diego, CA (US); Pooria PAKROOH, SAN MARCOS, CA (US); Manideep DUNNA, San Jose, CA (US); Jialing Li CHEN, San Diego, CA (US)

(21) Appl. No.: 19/445,284

(22) Filed: Jan. 9, 2026

Related U.S. Application Data
(60) Provisional application No. 63/744,133, filed on Jan. 10, 2025.

(51) Int. Cl. H04W 72/23; H04L 27/26

(52) U.S. Cl. CPC H04W 72/23; H04L 27/2636

(57) ABSTRACT

This disclosure provides methods, components, devices and systems for ambient power downlink bandwidth control. Some aspects more specifically relate to generating, by a transmitting device, a spreading waveform by concatenating a sequence of symbols having a first duration, and modulating an on-off keying (OOK) waveform having a different symbol duration with the spreading waveform. In some examples, the different waveforms may have different symbol durations, and symbol boundaries for the OOK waveform and the spreading waveform may or may not align in time. The spreading waveform may include a set of concatenated orthogonal frequency division multiplexing (OFDM) symbols, Barker sequences, or the like. The OOK waveform may include zero-mean OOK signals. The access point (AP) also may apply filtering to ensure that the generated waveform satisfies a spectral mask.

### CROSS REFERENCE

This Patent application claims the benefit of U.S. Provisional Patent Application No. 63/744,133 by SHELLHAMMER et al., entitled “AMBIENT POWER DOWNLINK BANDWIDTH CONTROL,” filed Jan. 10, 2025 assigned to the assignee hereof, and expressly incorporated herein.

### TECHNICAL FIELD

This disclosure relates generally to wireless communication and, more specifically, to ambient power downlink bandwidth control.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

An innovative aspect of the subject matter described in this disclosure can be implemented in a method for wireless communications by a station (STA). The method may include monitoring for one or more physical layer protocol data unit (PPDU) via a wireless channel, receiving, based on the monitoring, downlink wireless signaling including a spreading waveform including a sequence of concatenated symbols of a first duration and an on-off keying (OOK) waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration, and decoding at least a first PPDU of the downlink wireless signaling in accordance with the OOK waveform modulated with the spreading waveform.

Another aspect of the subject matter described in this disclosure can be implemented in a STA for wireless communications. The STA may include a processing system that includes processor circuitry and memory circuitry that stores code. The processing system may be configured to cause the STA to monitor for one or more PPDU via a wireless channel, receive, based on the monitoring, downlink wireless signaling including a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration, and decode at least a first PPDU of the downlink wireless signaling in accordance with the OOK waveform modulated with the spreading waveform.

Another aspect of the subject matter described in this disclosure can be implemented in a STA for wireless communications. The STA may include means for monitoring for one or more PPDU via a wireless channel, means for receiving, based on the monitoring, downlink wireless signaling including a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration, and means for decoding at least a first PPDU of the downlink wireless signaling in accordance with the OOK waveform modulated with the spreading waveform.

Another aspect of the subject matter described in this disclosure can be implemented in a non-transitory computer-readable medium storing code for wireless communications. The code may include instructions executable by one or more processors to monitor for one or more PPDU via a wireless channel, receive, based on the monitoring, downlink wireless signaling including a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration, and decode at least a first PPDU of the downlink wireless signaling in accordance with the OOK waveform modulated with the spreading waveform.

In some examples of the method, STAs, and non-transitory computer-readable medium described herein, the sequence of concatenated symbols includes a sequence of orthogonal frequency domain modulation symbols, or a set of Barker sequence symbols.

In some examples of the method, STAs, and non-transitory computer-readable medium described herein, the sequence of concatenated symbols includes a long training field symbol, a random binary phase shift keying symbol, a quadrature phase shift keying symbol, or any combination thereof.

In some examples of the method, STAs, and non-transitory computer-readable medium described herein, the set of symbols of the OOK waveform include Manchester encoding OOK symbols.

In some examples of the method, STAs, and non-transitory computer-readable medium described herein, a power spectral density does not exceed a power spectral density threshold across the wireless channel and the power spectral density falls within a threshold range across at least a portion of the wireless channel.

In some examples of the method, STAs, and non-transitory computer-readable medium described herein, the power spectral density satisfies a spectral mask for the wireless channel.

In some examples of the method, STAs, and non-transitory computer-readable medium described herein, a filtering may be applied to the wireless signaling to satisfy the spectral mask.

In some examples of the method, STAs, and non-transitory computer-readable medium described herein, a subset of tones of a set of multiple tones may be randomly populated, the subset of tones corresponding to a multi-point Fast Fourier Transform.

In some examples of the method, STAs, and non-transitory computer-readable medium described herein, the STA includes a backscatter device and the method, apparatuses, and non-transitory computer-readable medium may include further operations, features, means, or instructions for applying the spreading waveform including the sequence of concatenated symbols of the first duration to downlink rate less than or equal to 250 kilobits per second.

In some examples of the method, STAs, and non-transitory computer-readable medium described herein, the STA includes a non-backscatter device and the method, apparatuses, and non-transitory computer-readable medium may include further operations, features, means, or instructions for applying the spreading waveform including the sequence of concatenated symbols of the first duration to downlink rate less than or equal to one megabit per second.

In some examples of the method, STAs, and non-transitory computer-readable medium described herein, the OOK waveform may have a zero-mean value.

A method for wireless communications by an AP is described. The method may include generating a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration and transmitting the wireless signaling including or more physical layer protocol data units (PPDUs) via a wireless channel based on the generating.

An AP for wireless communications is described. The AP may include a processing system that includes processor circuitry and memory circuitry that stores code. The processing system may be configured to cause the AP to generate a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration and transmit the wireless signaling including or more PPDUs via a wireless channel based on the generating.

Another AP for wireless communications is described. The AP may include means for generating a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration and means for transmitting the wireless signaling including or more PPDUs via a wireless channel based on the generating.

A non-transitory computer-readable medium storing code for wireless communications is described. The code may include instructions executable by one or more processors to generate a spreading waveform including a sequence of concatenated symbols of a first duration and an OOK waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration and transmit the wireless signaling including or more physical layer PPDUs via a wireless channel based on the generating.

In some examples of the method, APs, and non-transitory computer-readable medium described herein, the sequence of concatenated symbols includes a sequence of orthogonal frequency domain modulation symbols, or a set of Barker sequence symbols.

In some examples of the method, APs, and non-transitory computer-readable medium described herein, the sequence of concatenated symbols includes a long training field symbol, a random binary phase shift keying symbol, a quadrature phase shift keying symbol, or any combination thereof.

In some examples of the method, APs, and non-transitory computer-readable medium described herein, the set of symbols of the OOK waveform include Manchester encoding OOK symbols.

In some examples of the method, APs, and non-transitory computer-readable medium described herein, transmitting the wireless signaling may include operations, features, means, or instructions for transmitting the wireless signaling according to a transmit power where a power spectral density does not exceed a power spectral density threshold across the wireless channel and the power spectral density falls within a threshold range across at least a portion of the wireless channel.

In some examples of the method, APs, and non-transitory computer-readable medium described herein, the power spectral density satisfies a spectral mask for the wireless channel.

Some examples of the method, APs, and non-transitory computer-readable medium described herein may further include operations, features, means, or instructions for applying a filter to the wireless signaling to satisfy the spectral mask.

In some examples of the method, APs, and non-transitory computer-readable medium described herein, randomly populating a subset of tones of a set of multiple tones corresponding to a multi-point Fast Fourier Transform and concatenating the subset of populated tones, where the spreading waveform may be based on the concatenating.

Some examples of the method, APs, and non-transitory computer-readable medium described herein may further include operations, features, means, or instructions for applying the spreading waveform including the sequence of concatenated symbols of the first duration to downlink rate less than or equal to 250 kilobits per second.

Some examples of the method, APs, and non-transitory computer-readable medium described herein may further include operations, features, means, or instructions for applying the spreading waveform including the sequence of concatenated symbols of the first duration to downlink rate less than or equal to one megabit per second.

In some examples of the method, APs, and non-transitory computer-readable medium described herein, the OOK waveform may have a zero-mean value.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example physical layer (PHY) protocol data unit (PPDU) usable for communications between a wireless AP and one or more wireless STAs.

FIG. 3 shows a hierarchical format of an example PPDU usable for communications between a wireless AP and one or more wireless STAs.

FIG. 4 shows a frequency diagram depicting an example distributed tone mapping.

FIG. 5 shows a pictorial diagram of another example wireless communication network.

FIG. 6 shows an example of a waveform diagram that supports ambient power downlink bandwidth control.

FIG. 7 shows an example of a waveform diagram that supports ambient power downlink bandwidth control.

FIG. 8 shows an example of a waveform diagram that supports ambient power downlink bandwidth control.

FIG. 9 shows an example of a process flow that supports ambient power downlink bandwidth control.

FIG. 10 shows a block diagram of an example wireless communication device that supports ambient power downlink bandwidth control.

FIG. 11 shows a block diagram of an example wireless communication device that supports ambient power downlink bandwidth control.

FIG. 12 shows a flowchart illustrating an example process performable by or at a station (STA) that supports ambient power downlink bandwidth control.

FIG. 13 shows a flowchart illustrating an example process performable by or at an access point (AP) that supports ambient power downlink bandwidth control.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

In some wireless communication networks, a receiving device (such as a station (STA) may be a low power device, such as a backscatter device or a non-backscatter device. Downlink signaling from an access point (AP) to such devices (such as, STAs) may be supported at one or more data rates. For example, such low power devices may support a first downlink data rate (such as, up to 1 Megabit per second (such as, for non-backscatter devices), or may support a second downlink data rate (such as, up to 250 kilobit per second. Some wireless signaling may be subject to regulations or other limitations with respect to power limits (such as, transmission power limitations in terms of dBm), power spectrum density (such as, in terms of dBm/MHz) or both. For instance, wireless communications may be limited (such as, on a wireless channel, such as a 20 MHz channel) to a power limit of 20 dBm, a power spectral power spectral density (PSD) limit of 10 dBm/MHz, or both. Wider bandwidths may allow for higher transmit power from a transmitting device (such as an AP) where such limitations are in place. Some wireless devices may support transmission using on-off keying (OOK) waveforms (such as, 2 μs or 4 μs symbol durations). Some wireless devices may support transmissions using direct sequence spread spectrum (DSSS) waveforms. DSSS systems may utilize a code (such as, an 11-bit Barker code) to spread differential phase shift keying signals. The duration of such differential phase shift keying symbols may be 1 μs. If an 11-bit Barker code is applied, the resulting waveform corresponds to a large channel, and a large amount of filtering may be used or required. Even shorter codes may be used, but such shorter codes may result in spectrum that is not very flat. That is, a large portion of an available channel may remain unused or inefficiently used because the total transmit power for the channel is limited by a threshold (such as, 20 dBm).

Various aspects relate generally to high transmission power for downlink signaling to ambient power devices. Some aspects more specifically relate to generating a spreading waveform (such as, an OFDM waveform) by concatenating a sequence of symbols having a first duration (such as, OFDM symbols having a 4 μs symbol duration, or a 16 μs duration, among other examples), and modulating an OOK waveform having a different symbol duration (such as, a 0.5 μs duration) with the spreading waveform. In some examples, the different waveforms may have different symbol durations, and symbol boundaries for the OOK waveform and the spreading waveform may or may not align in time. The spreading waveform may include a set of concatenated OFDM symbols, Barker sequences, or the like. The OOK waveform may include zero-mean OOK signals. The AP also may apply filtering to ensure that the generated waveform satisfies a spectral mask (such as, a DSSS spectral mask, or an OFDM spectral mask).

Particular aspects of the subject matter described in this disclosure can be implemented to realize one or more of the following potential advantages. In some examples, by transmitting downlink signaling to a low power device using a zero-mean OOK signal modulated with the OFDM spreading waveform, the described techniques can be used to increase a transmit power at the AP while maintaining a relatively flat spectrum across a downlink channel. The spreading waveform may allow for a higher transmit power in some regulatory domains which have power spectral density (PSD) limits. By effectively increasing the transmit power, the AP may increase the likelihood of reception by the low-power STA. The increased transmit power and improved reception at the STA may result in more efficient use of available resources, improved throughput, and more reliable downlink signaling.

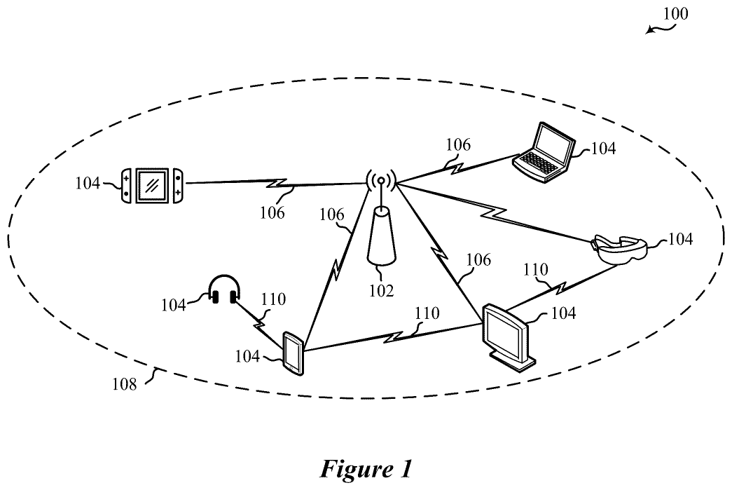

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHz-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communications network 100) may use integrated mm Wave (IMMW) techniques to support operations in these frequency bands. To manage the relatively high attenuation losses and other path losses associated with the mm Wave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mm Wave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mm Wave frequencies. Particular RF and analog designs, such as RF front end designs, antenna integration designs, and conversion architecture designs, may be implemented in APs 102 and STAs 104 to support mm Wave operation.

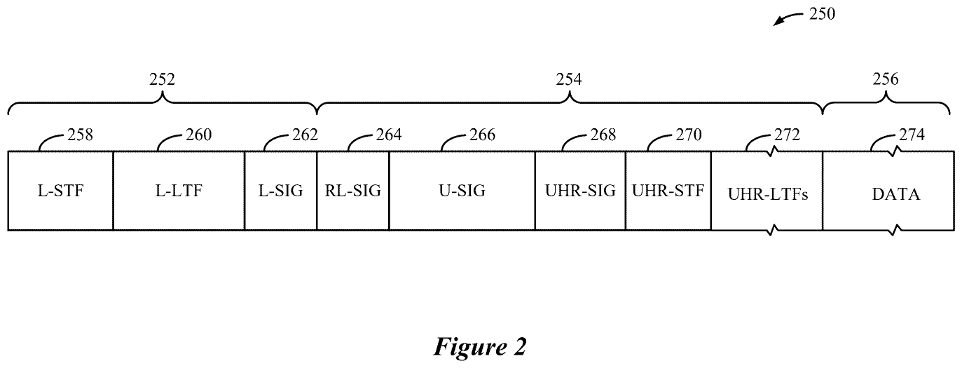

FIG. 2 shows an example physical layer (PHY) protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264, a universal signal field 266 (referred to herein as “U-SIG 266”) and a UHR signal field 268 (referred to herein as “UHR-SIG 268”). The presence of RL-SIG 264 and U-SIG 266 may indicate to UHR or later version-compliant STAs 104 that the PPDU 250 is a UHR PPDU or a PPDU conforming to any later (post-UHR) version of a new wireless communication protocol conforming to a future IEEE 802.11 wireless communication protocol standard. One or both of U-SIG 266 and UHR-SIG 268 may be structured as, and carry version-dependent information for, other wireless communication protocol versions associated with amendments to the IEEE family of standards beyond UHR. For example, U-SIG 266 may be used by a receiving device (such as an AP 102 or a STA 104) to interpret bits in one or more of UHR-SIG 268 or the data field 274. U-SIG 266 may include one or more universal, version-independent fields and one or more version-dependent fields. Information in the universal fields may include, for example, a version identifier (starting from the IEEE 802.11be amendment and beyond) and channel occupancy and coexistence information (such as a punctured channel indication). The version-dependent fields may include format information fields used for interpreting other fields of U-SIG 266 and UHR-SIG 268 and additional information fields or single user (SU)-specific fields that may be useful to intended recipients. In some implementations, the version-dependent fields may include at least a PPDU format field to indicate a general PPDU format for the PPDU 250 (such as a trigger-based (TB), a single-user (SU), or a multi-user (MU) PPDU format). Like L-STF 258, L-LTF 260, and L-SIG 262, the information in U-SIG 266 and UHR-SIG 268 may be duplicated and transmitted in each of the component 20 MHz channels in instances involving the use of a bonded channel.

The non-legacy portion 254 further includes an additional short training field 270 (referred to herein as “UHR-STF 270,” although it may be structured as, and carry version-dependent information for, other wireless communication protocol versions beyond UHR) and one or more additional long training fields 272 (referred to herein as “UHR-LTFs 272,” although they may be structured as, and carry version-dependent information for, other wireless communication protocol versions beyond UHR). UHR-STF 270 may be used for timing and frequency tracking and AGC, and UHR-LTF 272 may be used for more refined channel estimation.

UHR-SIG 268 may be used by an AP 102 to identify and inform one or multiple STAs 104 that the AP 102 has scheduled uplink (UL) or downlink (DL) resources for them. UHR-SIG 268 may be decoded by each compatible STA 104 served by the AP 102. UHR-SIG 268 also may generally be used by the receiving device to interpret bits in the data field 274. For example, UHR-SIG 268 may include resource unit (RU) allocation information, spatial stream configuration information, and per-user (such as STA-specific) signaling information. Each UHR-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 274.

In some wireless communications systems, a STA 104 or an AP 102 may transmit the PPDU 250 over bandwidths larger than the 20 MHz, 40 MHz, 80 MHz, 160 MHz, and 320 MHz bandwidths supported by previous generations of IEEE-compliant wireless communication systems. For example, the PPDU 250 may support 480 MHz or 640 MHz bandwidth communications. By increasing the channel bandwidth of the PPDU 250 to 480 MHz or 640 MHz, more data may be transmitted because more or larger RUs are available based on the larger bandwidth, and accordingly, higher peak throughput or increased capacity may be achieved. Parameters for assembling and transmitting the 480 MHz or 640 MHz PPDUs may be defined to account for the larger bandwidths. For example, parameters or designs such as the tone plans, resource unit allocation indications, spatial reuse fields, UHR-STFs 270, UHR-LTFs 272, pilot signal locations, phase shifts, and spectral masks may be optimized or otherwise selected in accordance with the 480 MHz or 640 MHz bandwidths. In some examples, the spatial reuse fields may enable multiple BSSs to operate on the same 480 MHz or 640 MHz bandwidth channels.

In some examples, UHR-capable STAs 104 and APs 102 may support unequal modulation techniques (also referred to as unequal quadrature amplitude modulation (QAM)) with joint encoding across multiple streams for MIMO communications. For example, while different data streams may be transmitted using different spatial streams, or different resource units (RUs), or both, different spatial streams or RUs may be associated with different levels of quality (such as a different signal to noise ratios (SNRs)), and it may be advantageous to use different (unequal) MCSs for different spatial streams or RUs.

To support unequal modulation, an AP 102 may transmit signaling that indicates unequal MCSs across spatial streams or RUs to multiple STAs 104. For example, the AP 102 may transmit an MCS configuration message, which may be an example of a PHY preamble included in control signaling for PHY layer configuration, to indicate the unequal MCSs. In some examples, an MCS field of the MCS configuration message may include entries for unequal QAM schemes across multiple spatial streams, where the multiple spatial streams may be encoding with the same code rate.

In some wireless communication systems, wireless communication devices may support low density parity check (LDPC) coding for forward error correcting purposes to increase the likelihood of accurate data transmission. In some examples, UHR-capable STAs 104 and APs 102 may be capable of selecting among multiple LDPC codeword lengths, including 648 bits, 1296 bits and 1944 bits (defined in legacy IEEE 802.11 wireless communications protocol standards), as well as even longer (extended) codeword lengths, which may increase as operating bandwidths increase, higher modulation orders are introduced, or more spatial streams are available. Using longer LDPC codewords may achieve lower block error rates in some channels, such as channels associated with additive white Gaussian noise. Longer LDPC codewords also may enable more reliable communications in channels with lower SNRs. To facilitate the use of multiple LDPC codeword lengths, a STA 104 and an AP 102 may each include multiple LDPC encoders and multiple LDPC decoders. In some examples, such a STA 104 or AP 102 may connect, aggregate or otherwise utilize multiple encoders to implement a larger single encoder capable of encoding a longer codeword, or similarly, utilize multiple decoders to implement a larger single decoder capable of decoding a longer codeword, which may increase performance gains associated with larger block sizes without substantially increasing the hardware cost or complexity. In some examples, to generate an extended LDPC codeword, a STA 104 or an AP 102 may implement one or more lifting operations to extend a shorter codeword, with each lifting operation extending the previously lifted codeword. A “lifting” operation enables LDPC codes to be implemented using parallel encoding or decoding implementations while also reducing the complexity typically associated with large LDPC codewords. In some examples, a STA 104 or an AP 102 may use mixed codeword lengths for a given transmission. For example, the STA 104 or the AP 102 may encode input bits into one or more codewords having a first, longer codeword length (more than 1944 bits) and one or more codewords having a second, shorter codeword length (1944 bits or less). In such examples, the STA 104 or the AP 102 may perform shortening or puncturing on the codewords having the longer codeword length, or on the codewords having the shorter codeword length, or both.

To support increased range or rate-over-range, a STA 104 and an AP 102 may support extended long range (ELR) PPDU formats. The use of an ELR PPDU format can enable the achievement of a target data rate while maintaining an existing coverage range, reduce an uplink/downlink power imbalance (due to, for example, one or more regulations or hardware differences at the uplink and downlink devices), or extend a coverage range while maintaining a similar, or slightly lower, data rate as compared with other PPDU formats. In some examples, an ELR PPDU may be transmitted over a narrow bandwidth, which may have a lower noise floor and thus higher SNR, thereby extending the coverage range. The reliability of the transmission of an ELR PPDU also may be increased as a result of using various optimized coding rates, coded bit repetition schemes, or duplication schemes, which may provide for improved decodability and fewer retransmissions. In some examples, the U-SIG 266 of an ELR PPDU 250 may include a first indication (such as a codepoint of a PHY version identifier subfield within a version-independent portion of the U-SIG 266 or a value of an ELR subfield within a version-dependent portion of the U-SIG 266) that the PPDU 250 is associated with an ELR format. The U-SIG 266 of an ELR PPDU 250 may include a second indication (such as a STA identifier subfield within the version-dependent portion of the U-SIG 266) of an intended receiver of the PPDU. In some examples, an ELR PPDU 250 may include an ELR-signature (ELR-SIG) field that includes an uplink/downlink indicator subfield, a length subfield, a coding indicator subfield, and a modulation and coding scheme (MCS) subfield.

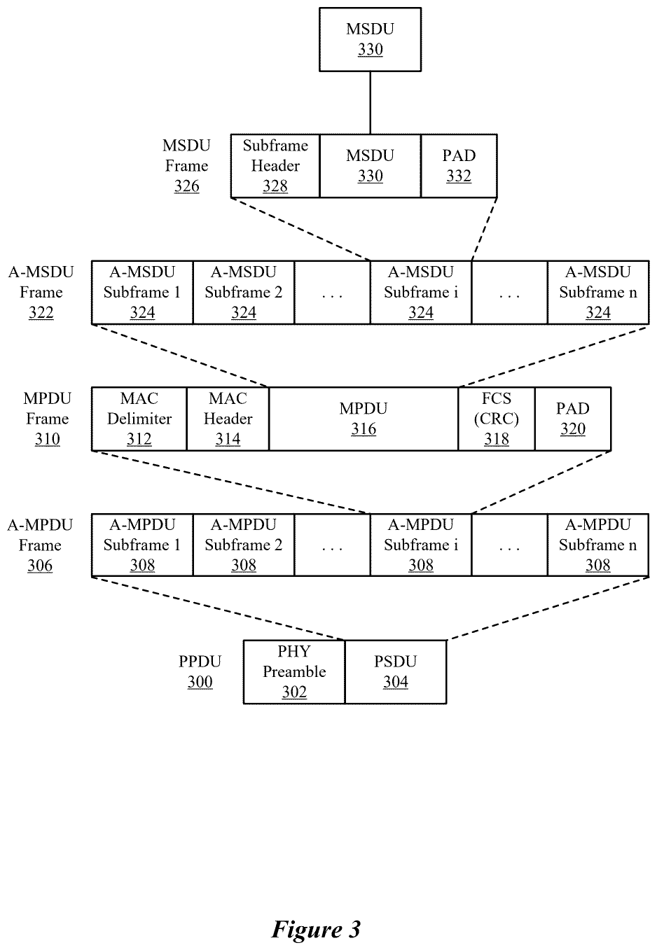

FIG. 3 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 308 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (such as the FCS field 318 may include a cyclic redundancy check (CRC)) and padding bits 320. The MPDU 316 may carry one or more MAC service data units (MSDUs) 330. For example, the MPDU 316 may carry an aggregated MSDU (A-MSDU) 322 including multiple A-MSDU subframes 324. Each A-MSDU subframe 324 may be associated with an MSDU frame 326 and may contain a corresponding MSDU 330 preceded by a subframe header 328 and, in some examples, followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body. The MAC header 314 includes a duration field indicating a duration extending from the end of the PPDU until at least the end of an acknowledgement (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 314 also includes one or more fields indicating addresses for the data encapsulated within the frame body. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (such as by generating a message integrity check (MIC) for one or more relevant fields.

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or the STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

APs and STAs (such as the AP 102 and the STAs 104 described with reference to FIG. 1) that include multiple antennas may support various diversity schemes. For example, spatial diversity may be used by one or both of a transmitting device (such as an AP 102 or a STA 104) or a receiving device (such as an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift, or a power level, to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHZ, 5 GHZ, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (such as one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (such as switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (such as monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

A wireless communication device may include an auxiliary radio and a main radio and may operate in both an auxiliary radio mode and a main radio mode. The wireless communication device may be a STA or an AP, such as, for example, the AP 102 and STAs 104 described with reference to FIG. 1. Additionally, the wireless communication device may support communications over a single wireless link or over multiple wireless links. For example, the wireless communication device may be an AP MLD or a non-AP MLD. The auxiliary radio mode may support communications with relatively lower data rates (such as ≤24 Mbps) than the main radio mode. For example, while operating in an auxiliary radio mode, the auxiliary radio of the wireless communication device may transmit messages having a non-high throughput (non-HT) format whereas, while operating in a main radio mode, the main radio may transmit messages having an EHT, UHR or later protocol format. A wireless communication device that uses an auxiliary radio in addition to a main radio may improve reliability and reduce latency and power consumption. For example, the wireless communication device may improve reliability by using the auxiliary radio to transmit/receive redundancies, facilitate fast feedback exchanges, or otherwise increase robustness for high-priority or otherwise important packets (such as packets containing latency-sensitive traffic or traffic requiring high reliability). For example, to support latency-sensitive traffic insertion in uplink communications, an AP may utilize its auxiliary radio for detection of low latency PPDU (LL-PPDU) subframes associated with latency-sensitive traffic. As another example, the wireless communication device also may use the auxiliary radio to scan for channels while communicating on another channel via the main radio, thereby reducing latency associated with a transition between channels by eliminating the time for the main radio to scan for channels. As another example, use of the auxiliary radio may reduce power consumption by enabling the main radio to enter a sleep mode and monitoring for wake-up signals via the auxiliary radio, which is designed to consume less power than the main radio.

The auxiliary radio may support both transmitting and receiving (Tx/Rx) modes of operation, or may support receiving-only (Rx-only) modes of operation. If the wireless communication device is an MLD, the wireless communication device may communicate on one or more wireless links using a main radio and may simultaneously communicate on one or more wireless links using one or more auxiliary radios. In an MLD scenario in which the auxiliary radio is Rx-only capable (an “Aux-Rx” mode), the wireless communication device may transmit and receive communications on a first wireless link using the main radio but may simultaneously receive (but not transmit) communications on a second wireless link using the auxiliary radio. In an MLD scenario in which the auxiliary radio is Tx/Rx capable (an “Aux-Tx/Rx” mode), the wireless communication device may transmit and receive communications on a first wireless link using the main radio and may simultaneously transmit and receive communications on a second wireless link using the auxiliary radio. In an MLD scenario, the wireless communication device may transition the main radio from a second wireless link to a first wireless link and may correspondingly transition the auxiliary radio from the first wireless link to the second wireless link. For example, the wireless communication device's auxiliary radio may receive control signaling on the second wireless link from another wireless communication device that triggers the wireless communication device to switch the use of its radios between wireless links. If the wireless communication device is not an MLD, the wireless communication device may transition from using its auxiliary radio to using its main radio mode on a single wireless link. For example, the wireless communication device's auxiliary radio may receive control signaling from another wireless communication device that triggers the wireless communication device to initiate the transition from use of the auxiliary radio to the main radio on the wireless link. Upon such a transition, the wireless communication device may place the auxiliary radio in a powered-down sleep state while activating the main radio to an awake state. Similarly, the wireless communication may transition from using its main radio to its auxiliary radio on the wireless link upon receiving a triggering control signal.

In some examples, the wireless communication device (such as a STA) may indicate (such as via a broadcast frame such as a beacon frame or other management frame), to other wireless communication devices (such as an AP), parameters associated with an auxiliary radio mode or parameters associated with transitioning from the auxiliary radio mode to a main radio mode for a given wireless link. For example, the wireless communication device may indicate a message format for the auxiliary radio mode. The indicated message format may be associated with a particular PPDU format (such as non-HT) or a supported data rate (such as ≤24 Mbps).

In some examples, the wireless communication device may indicate transition delays corresponding to time durations associated with switching from the auxiliary mode to the main radio mode as well as switching from the main radio mode to the auxiliary radio mode for a wireless link. A second wireless communication device may schedule data communications with the wireless communication device based on the transition delay so that data is not transmitted to the wireless communication device during the transition delay, during which data may be lost. The duration of the transition delay may generally be dependent on whether the auxiliary radio supports Tx/Rx or Rx-only modes of operation. For example, if the auxiliary radio supports Tx/Rx, the auxiliary radio may transmit an acknowledgment message in response to a request to transition to the main radio mode for a wireless link, which may extend the transition delay. Additionally, or alternatively, the duration of the transition delay may depend on whether the main radio is transitioning from a sleep mode or from a different wireless link.

The auxiliary radio may perform additional functions while the wireless communication device communicates with a second wireless communication device via a wireless link using the main radio. The functions that may be performed may generally depend on whether the auxiliary radio supports Tx/Rx or Rx-only modes of operation or whether the wireless communication device is an MLD capable of supporting communications over more than one wireless link. For example, in an Aux-Rx mode, the auxiliary radio of a wireless communication device (such as a non-AP MLD) may monitor or collect channel state (or quality) information or statistics (such as BSS load, interference profiles of neighboring BSSs and multi-NAV multi-primary maintenance) in a passive manner. In an Aux Tx/Rx mode, the auxiliary radio of the non-AP MLD may monitor or collect channel state information or statistics as well as transmit a report to an AP MLD that includes the collected channel state information or statistics without involvement of the main radio. In some examples, while operating in an Aux-Rx mode, a first wireless communication device (such as an AP MLD) may use the auxiliary radio to receive control communications or high-priority or otherwise important data communications from the second wireless communication device (such as another AP MLD) using a second wireless link while its main radio uses the first wireless link to perform data transfer. In contrast, in an Aux-Tx/Rx mode, an AP MLD may use the auxiliary radio to both receive and transmit control communications or high-priority or otherwise important data communications. In some examples, while operating in an Aux-Rx mode, a non-AP MLD's auxiliary radio may monitor or scan for potential APs to associate with on alternative wireless channels than the wireless channel on which the non-AP MLD's main radio is still communicating with a previously connected AP. In an Aux-Tx/Rx mode, an MLD may use the auxiliary radio to both scan for and perform association or authentication on other wireless channels.

In some environments, locations, or conditions, a regulatory body may impose a power spectral density (PSD) limit for one or more communication channels or for an entire band (such as the 6 GHz band). A PSD is a measure of transmit power as a function of a unit bandwidth (such as per 1 MHz). The total transmit power of a transmission is consequently the product of the PSD and the total bandwidth by which the transmission is sent. Unlike the 2.4 GHz and 5 GHz bands, the United States Federal Communications Commission (FCC) has established PSD limits for low power devices when operating in the 6 GHz band. The FCC has defined three power classes for operation in the 6 GHz band: standard power, low power indoor, and very low power. Some APs 102 and STAs 104 that operate in the 6 GHz band may conform to the low power indoor (LPI) power class, which limits the transmit power of APs 102 and STAs 104 to 5 decibel-milliwatts per megahertz (dBm/MHz) and −1 dBm/MHz, respectively. In other words, transmit power in the 6 GHz band is PSD-limited on a per-MHz basis.

Such PSD limits can undesirably reduce transmission ranges, reduce packet detection capabilities, and reduce channel estimation capabilities of APs 102 and STAs 104. In some examples in which transmissions are subject to a PSD limit, the AP 102 or the STAs 104 of a wireless communication network 100 may transmit over a greater transmission bandwidth to allow for an increase in the total transmit power, which may increase an SNR and extend coverage of the wireless communication devices. For example, to overcome or extend the PSD limit and improve SNR for low power devices operating in PSD-limited bands, 802.11be introduced a duplicate (DUP) mode for a transmission, by which data in a payload portion of a PPDU is modulated for transmission over a “base” frequency sub-band, such as a first RU of an OFDMA transmission, and copied over (such as duplicated) to another frequency sub-band, such as a second RU of the OFDMA transmission. In DUP mode, two copies of the data are to be transmitted, and, for each of the duplicate RUs, using dual carrier modulation (DCM), which also has the effect of copying the data such that two copies of the data are carried by each of the duplicate RUs, so that, for example, four copies of the data are transmitted. While the data rate for transmission of each copy of the user data using the DUP mode may be the same as a data rate for a transmission using a “normal” mode, the transmit power for the transmission using the DUP mode may be essentially multiplied by the number of copies of the data being transmitted, at the expense of requiring an increased bandwidth. As such, using the DUP mode may extend range but reduce spectrum efficiency.

In some other examples in which transmissions are subject to a PSD limit, a distributed tone mapping operation may be used to increase the bandwidth via which a STA 104 transmits an uplink communication to the AP 102. As used herein, the term “distributed transmission” refers to a PPDU transmission on noncontiguous tones (or subcarriers) of a wireless channel. In contrast, the term “contiguous transmission” refers to a PPDU transmission on contiguous tones. As used herein, a logical RU represents a number of tones or subcarriers that are allocated to a given STA 104 for transmission of a PPDU. As used herein, the term “regular RU” (or rRU) refers to any RU or MRU tone plan that is not distributed, such as a configuration supported by 802.11be or earlier versions of the IEEE 802.11 family of wireless communication protocol standards. As used herein, the term “distributed RU” (or dRU) refers to the tones distributed across a set of noncontiguous subcarrier indices to which a logical RU is mapped. The term “distributed tone plan” refers to the set of noncontiguous subcarrier indices associated with a dRU. The channel or portion of a channel within which the distributed tones are interspersed is referred to as a spreading bandwidth, which may be, for example, 40 MHz, 80 MHz or more. The use of dRUs may be limited to uplink communications because benefits to addressing PSD limits may only be present for uplink communications.

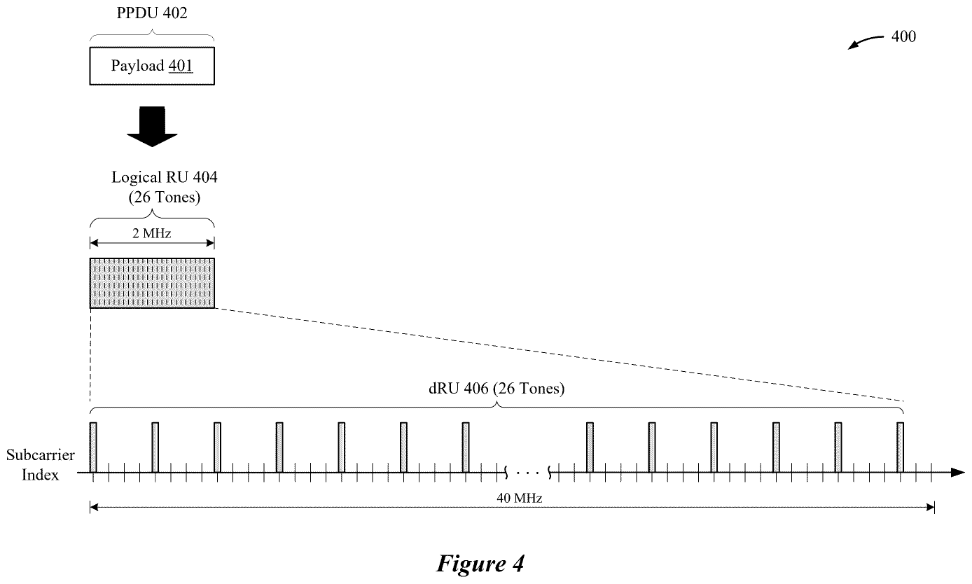

FIG. 4 shows a frequency diagram 400 depicting an example distributed tone mapping. More specifically, FIG. 4 shows an example mapping of how the tones of a payload 401 of a PPDU 402 are distributed for transmission over a spreading bandwidth of a wireless channel. In the illustrated example, the tones in a logical RU 404 (which may represent an rRU of non-distributed tones in accordance with a legacy tone plan) associated with payload 401 are mapped to a distributed RU (dRU) 406 in accordance with a distributed tone plan.

Aspects of the present disclosure recognize that by distributing the tones across a wider bandwidth, the per-tone transmit power of a logical RU 404 may be increased to provide greater flexibility in medium utilization for PSD-limited wireless channels. For example, when mapped to an rRU such as logical RU 404, the transmit power of the logical RU 404 may be severely limited based on the PSD of the wireless channel. For example, the LPI power class limits the transmit power of APs 102 and STAs 104 to 5 dBm/MHz and −1 dBm/MHz, respectively, in the 6 GHz band. As such, the per-tone transmit power of the logical RU 404 is limited by the number of tones mapped to each 1 MHz subchannel of the wireless channel.

By enabling a STA 104 to map modulation symbols in a distributed manner onto noncontiguous tones interspersed throughout all or a portion of a wireless channel, distributed transmissions may enable an increase in the per-tone transmit power used for each individual distributed tone, and thus the overall transmit power of the PPDU 402, without exceeding the PSD limits of the wireless channel. As shown in the example of FIG. 4, the STA 104 may map logical RU 404 to a set of 26 noncontiguous subcarrier indices spread across a 40 MHz wireless channel (also referred to herein as a “spreading bandwidth”). Compared to the tone mapping described above with respect to the legacy tone plan, the distributed tone mapping depicted in FIG. 4 effectively reduces the number of tones (of the logical RU 404) in each 1 MHz subchannel. For example, each of the 26 tones can be mapped to a different 1 MHz subchannel of the 40 MHz channel. As a result, each AP 102 or STA 104 implementing the distributed tone mapping of FIG. 4 can maximize its per-tone transmit power (which may maximize the overall transmit power of the logical RU 404).

In some examples (not shown in FIG. 4), multiple logical RUs may be mapped to interleaved subcarrier indices of a shared wireless channel. For example, a STA 104 may modulate a portion of the symbols on a number of tones representing multiple logical RUs to noncontiguous subcarrier indices associated with a shared wireless channel in accordance with a distributed tone plan. Furthermore, distributed transmissions by multiple STAs 104 may be multiplexed onto different sets of distributed tones of a shared wireless channel such as to enable an increase in the transmit power of each device without sacrificing spectral efficiency. Such increases in transmit power can be combined with some MCSs to increase the range and throughput of wireless communications on PSD-limited wireless channels. Distributed transmissions also may improve packet detection and channel estimation capabilities.

To support distributed transmissions, new packet designs and signaling may be used to indicate whether a PPDU 402 is transmitted on tones spanning an rRU, such as a logical RU 404 (according to a legacy tone plan), or a dRU 406 (according to a distributed tone plan). For example, the IEEE 802.11be standard amendment or earlier versions of the IEEE 802.11 family of wireless communication protocol standards define a trigger frame format which can be used to solicit the transmission of a trigger-based (TB) PPDU from one or more STAs 104. The trigger frame allocates resources to the STAs 104 for the transmission of the TB PPDU and indicates how the TB PPDU is to be configured for transmission. For example, the trigger frame may indicate a logical RU or MRU allocated for transmission in the TB PDDU. In some examples, the trigger frame may be further configured to carry tone distribution information indicating whether the logical RU (or MRU) maps to an rRU or a dRU.

In some implementations, a STA 104 may include a distributed tone mapper that maps the logical RU 404 to the dRU 406 in the frequency domain. The dRU 406 is converted to a time-domain signal (such as by an inverse fast Fourier transform (IFFT)) for transmission over a wireless channel. The AP 102 may receive the time-domain signal and reconstruct the dRU 406 (such as by a fast Fourier transform (FFT)). In some implementations, the AP 102 may include a distributed tone demapper that demaps the dRU 406 to the logical RU 404. In other words, the distributed tone demapper reverses the mapping performed by the distributed tone mapper at the STA 104. The AP 102 can recover the information carried (or modulated) on the logical RU 404 as a result of the demapping.

In the example of FIG. 4, the logical RU 404 is distributed evenly across the spreading bandwidth. While the example shown in FIG. 4 illustrates a spreading bandwidth of 40 MHz, spreading bandwidths also may include 80 MHz, 160 MHz, or 320 MHz. In some implementations, the logical RU 404 can be mapped to any suitable pattern of noncontiguous subcarrier indices. For example, in various implementations, the distance between any pair of adjacent modulated tones may be less than or greater than the distances depicted in FIG. 4.

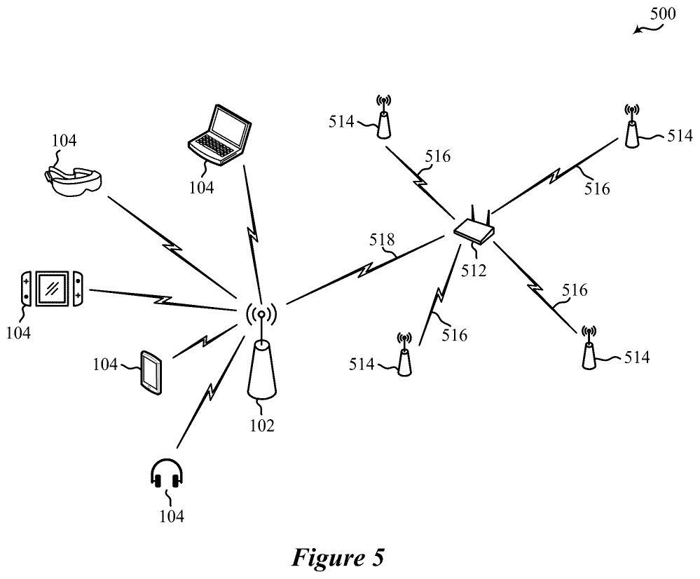

FIG. 5 shows a pictorial diagram of another example wireless communication network 500. According to some aspects, the wireless communication network 500 can be an example of a mesh network, an IoT network, or a sensor network in accordance with one or more of the IEEE 802.11 family of wireless communication protocol standards (including the 802.11ah amendment). The wireless communication network 500 may include multiple wireless communication devices 514, which in some implementations may include APs 102, STAs 104, or both. The wireless communication devices 514 may represent various devices such as display devices (such as TVs, computer monitors, navigation systems, among others), music or other audio or stereo devices, remote control devices (“remotes”), printers, kitchen or other household appliances, among other examples.

In some examples, the wireless communication devices 514 sense, measure, collect or otherwise obtain and process data and transmit such raw or processed data to an intermediate device 512 for subsequent processing or distribution. Additionally, or alternatively, the intermediate device 512 may transmit control information, digital content (such as audio or video data), configuration information or other instructions to the wireless communication devices 514. The intermediate device 512 and the wireless communication devices 514 can communicate with one another via wireless communication links 516. In some examples, the wireless communication links 516 include Bluetooth links or other PAN or short-range communication links.

In some examples, the intermediate device 512 also may be configured for wireless communication with other networks such as with a WLAN or a wireless (such as cellular) wide area network (WWAN), which may, in turn, provide access to external networks including the Internet. For example, the intermediate device 512 may associate and communicate, over a Wi-Fi link 518, with an AP 102 of a wireless communication network 500, which also may serve various STAs 104. In some examples, the intermediate device 512 is an example of a network gateway, for example, an IoT gateway. In such a manner, the intermediate device 512 may serve as an edge network bridge providing a Wi-Fi core backhaul for the IoT network including the wireless communication devices 514. In some examples, the intermediate device 512 can analyze, preprocess and aggregate data received from the wireless communication devices 514 locally at the edge before transmitting it to other devices or external networks via the Wi-Fi link 518. The intermediate device 512 also can provide additional security for the IoT network and the data it transports.

Aspects of transmissions may vary according to a distance between a transmitter (such as an AP 102 or a STA 104) and a receiver (such as another AP 102 or STA 104). Wireless communication devices (such as the AP 102 or the STA 104) may generally benefit from having information regarding the location or proximities of the various STAs 104 within the coverage area. In some examples, relevant distances may be determined (such as calculated or computed) using RTT-based ranging procedures. Additionally, in some examples, APs 102 and STAs 104 may perform ranging operations. Each ranging operation may involve an exchange of fine timing measurement (FTM) frames (such as those defined in the 802.11az amendment to the IEEE family of wireless communication protocol standards) to obtain measurements of RTT transmissions between the wireless communication devices.

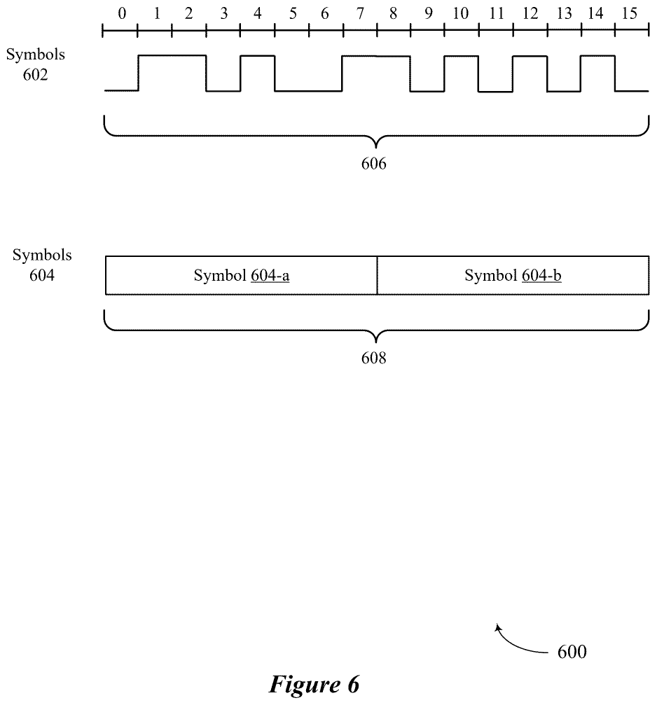

FIG. 6 shows an example of a waveform diagram 600 that supports ambient power downlink bandwidth control. The waveform diagram 600 may implement, or be implemented by, aspects of FIGS. 1-5. For example, a transmitting device (such as, an AP) and a receiving device (such as, a STA), which may be examples of corresponding devices described with reference to FIGS. 1-5, may perform wireless communications in accordance with the waveform diagram 600. In some examples, the transmitting device may be an example of an AP, or a reader device, among other examples. In some examples, the receiving device may be an example of a STA, a backscatter device, a non-backscatter device, or a tag, among other examples.

Some wireless communications systems may support low power or ultra-low power devices, which may be battery-less devices. Such low power devices may include non-backscatter devices (such as, a micro-power STA, or an active transmitter STA, supporting active transmitters) and backscatter devices (such as, a close-range monostatic backscatter device, or a bi-static backscatter device). Downlink signaling to such devices (such as, STAs) may be supported at one or more data rates. For example, such low power devices may support a first downlink data rate (such as, up to 1 megabit (Mb) per second (such as, for non-backscatter devices), or may support a second downlink data rate (such as, up to 250 kilobits (kb) per second).

Some wireless signaling may be subject to regulations or other limitations with respect to power limits (such as, transmission power limitations in terms of dBm), PSD (such as, in terms of dBm/MHz) or both. For instance, wireless communications may be limited (such as, on a wireless channel, such as a 20 MHz channel) to a power limit of 20 dBm, a PSD limit of 10 dBm/MHz, or both. Wider bandwidths may allow for higher transmit power from a transmitting device (such as an AP) where such limitations are in place. Such higher transmit power by transmitting devices may result in more effective or successful reception by low power receiving devices (such as, STAs).

Some wireless devices may support transmission using OOK waveforms, which may be constructed using an OFDM waveform. For instance, an OOK waveform constructed using an OFDM waveform may obtain a 4 MHz bandwidth. Some systems may support OOK symbol durations of 2 μs, or 4 μs. Some wireless devices may support transmission using direct sequence spread spectrum (DSSS) waveforms, which may control a bandwidth for some downlink data rates (such as, 250 kb/s downlink PPDUs). DSSS systems may utilize a code (such as, an 11-bit Barker code) to spread differential phase shift keying signals. The duration of such differential phase shift keying symbols may be 1 μs.

In some examples, for a DSSS physical layer waveform, an 11-bit Barker code may result in spreading spectrum to around 22 MHz (such as, if a filter is applied). Such DSSS waveforms may result in good usage of a channel (such as, a 20 MHz channel), but instead of a 1 μs differential phase shift keying symbol duration, the DSSS waveforms may result in a 0.5 μs symbol duration. If an 11-bit Barker code is applied, the resulting waveform corresponds to a 44 MHz channel, and a large amount of filtering may be utilized. Even shorter codes may be used, but such shorter codes result in spectrum that is not very flat. That is, a large portion of an available channel may remain unused or inefficiently used because the total transmit power for the channel is limited by a threshold (such as, 20 dBm).

Thus, the wireless communications system may benefit from utilization of short symbol durations (such as, an OFDM symbol duration of 0.5 μs). Such a symbol duration, for a given bandwidth (such as, a 20 MHz channel), may be defined by one or more parameter values. For example, an OFDM symbol duration may be defined by a size of a Fast Fourier Transform (FFT), which may be referred to as FFTSize, and a sampling rate, in accordance with Equation 1:

$$OFDM Symbol Duration = \frac{FF TSize}{Sampling Rate} . \qquad Equation 1$$

A bandwidth size may be approximately the same as, or similar to, a sampling rate, as illustrated by Equation 2, assuming all tones in the FFT are populated:

$$OFDM Symbol Duration = \frac{FFTSize}{Bandwidth} . \qquad Equation 2$$

For a short symbol (such as, an OFDM symbol), the OFDM symbol duration may be defined in accordance with Equation 3:

$$μ s = \frac{10}{20 MHz} \qquad Equation 3$$

Thus, in accordance with Equation 3, to support a 0.5 μs symbol duration, a ten-point FFT may be utilized (such as, the transmitting device may populate 10 tones). Such a small FFT may not provide a very flat spectrum (such as, not very many tones of a 20 MHz channel may be occupied, resulting in inefficient use of resources, decreased throughput, among other examples). Similarly, for a 0.5 OOK symbol in an ambient power 1 Mb/s downlink PPDU, a short Barker code or small OFDM FFT size may result in a spectrum that is not very flat. By generating waveforms using spreading waveforms, OOK waveforms, or both, having small symbol sizes and aligned symbol boundaries, downlink transmissions may be limited to a small quantity of populated tones, spectrum usage that is not very flat, and inefficient use of available system resources. Further, such waveforms may result in reduced transmit power (such as, because of the spectrum not being flat) by the transmitting device (such as, the AP), failed reception at the receiving device, increased and inefficient processing, or excessive filtering by the transmitter to satisfy one or more spectral masks.

Techniques described herein support use of different symbol durations for a spreading waveform and an OOK waveform, resulting in increased transmit power, and more effective reception at the receiving device. For example, the AP may utilize full-length symbols 604 (such as, OFDM symbols), and may concatenate a sequence of symbols 604 to generate a spreading waveform (such as, an OFDM spreading waveform 608). The AP also may modulate symbols 602 (such as, OOK symbols of an OOK waveform 606) with the OFDM spreading waveform 608. For example, the symbols 604 may be OFDM symbols having a symbol duration of 4 μs (such as, or a longer OFDM symbol duration of 16 μs). The OOK waveform 606 may be a zero-mean OOK signal. For instance, the OOK symbols 602 may be generated in accordance with Manchester encoding, and may have short symbol durations (such as, a symbol duration of 0.5 μs for symbols 0-15). The Symbols 604 (such as, OFDM symbols) may have a different symbol duration (such as, OFDM symbols with a symbol duration of 4 μs).

The spreading waveform 608 may not have the same symbol duration as the OOK waveform 606. For example, the smaller symbol duration of the symbols 602 and the longer duration of the symbols 604 may result in a ratio of the OOK symbols 602 to the OFDM symbols 604 (such as, 8:1, or 8 OOK symbols to every 1 OFDM symbol for a generated wireless signal based on the OOK waveform 606 modulated with the OFDM spreading waveform). In some examples, a data rate may be based on or otherwise related to such a ratio (such as, a higher data rate may result from a smaller symbol duration ratio between the symbols 602 and the symbols 604, such as 2:1, whereas a lower data rate may result from a larger symbol duration ratio between the symbols 602 and the symbols 604 such as 8:1). In some examples, a symbol duration of the symbols 602 may not even be a multiple of the symbol duration of the symbols 604. In some examples, at least some symbol boundaries of the symbols 602 may not align in time with the symbol boundaries of the symbols 604 (such as, as a result of varying symbol durations, or as a result of a symbol duration ratio that is not a one-to-all ratio, such as 3:2, or 5:3, among other examples). In some examples, an LTF may be an example of an OFDM symbol that can be used to construct the OFDM spreading waveform 608.

Such wireless signaling (such as, one or more PPDUs based on the OOK waveform 606 modulated with the spreading waveform 608) may be applied to a synchronization field, a data field, a training field (such as, a LTF, among other examples), or the like. The receiving device (such as, a low power device such as a STA, a tag, an RFID device, or the like) may not support filtering of downlink signaling, resulting in a higher signal to noise ratio (SNR). The higher transmit power supported by the wireless signaling described herein (such as, the OOK waveform 606 modulated with the spreading waveform 608) may support increased reliability of reception at the STA.

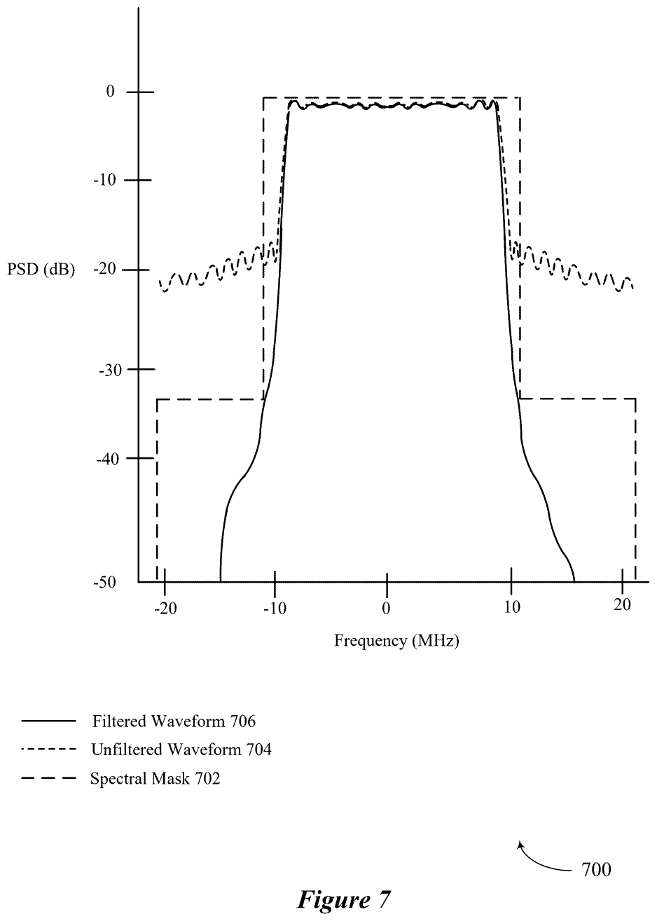

For example, a transmitting device (such as, the AP) may utilize a 64-point FFT, and may generate an OFDM symbol (such as, the OFDM symbol 604-a or the OFDM symbol 604-b) using a quantity of populated tones (such as, 46 populated tones) using random binary phase shift keying (BPSK) symbols. In some examples, instead of an OFDM symbol constructed from random BPSK symbols, an LTF may be used as an OFDM symbol in the OFDM spreading waveform. The AP may concatenate one or more such OFDM symbols 604 (such as, the OFDM symbol 604-a and the OFDM symbol 604-b), thereby generating a spreading waveform 608 (such as, an OFDM spreading waveform). The modulate the OOK waveform 606 (such as, a zero-mean OOK waveform) with the OFDM spreading waveform 608 (such as, the OFDM spreading waveform modulates the zero-mean OOK waveform). The AP also may apply filtering to meet one or more threshold PSD values (such as, a DSSS spectral mask or an OFDM spectral mask, among other examples), as described in greater detail with reference to FIG. 7.

FIG. 7 shows an example of a waveform diagram 700 that supports ambient power downlink bandwidth control. The waveform diagram 700 may implement, or be implemented by, aspects of FIGS. 1-6. For example, a transmitting device (such as, an AP) and a receiving device (such as, a STA), which may be examples of corresponding devices described with reference to FIGS. 1-6, may perform wireless communications in accordance with the waveform diagram 700. In some examples, the transmitting device may be an example of an AP, or a reader device, among other examples. In some examples, the receiving device may be an example of a STA, a backscatter device, a non-backscatter device, or a tag, among other examples.

As described in greater detail with reference to FIG. 6, the transmitting device (such as, an AP) may generate one or more PPDUs for transmission via wireless signaling (such as, via a waveform). The AP may generate a spreading waveform of concatenated symbols having a first duration (such as, OFDM symbols or Barker sequence symbols) and may modulate an OOK waveform having a second symbol duration (such as, different from or smaller than the first symbol duration) with the spreading waveform. The symbol boundaries of the different symbol sizes may or may not align in time, and the first symbol size may or may not be a multiple of the second symbol size (such as, one or more standards documents may not require the symbol sizes to be the same, or that symbol boundaries align in time, or that one symbol size be a multiple of another symbol size).

As illustrated with reference to FIG. 7, such a modulated waveform may satisfy a spectral mask 702 (such as, in some cases, based on some filtering applied by the AP). The spectral mask may limit PSD across a channel or band (such as, a 20 MHz channel). The unfiltered waveform 704 (such as, an unfiltered waveform generated by the spreading waveform that modulates the OOK waveform) may experience a relatively flat spectrum (such as, from −10 MHz to 10 MHz). However, without filtering, the unfiltered waveform 704 may not satisfy some aspects of the spectral mask (such as, from about −20 MHz to about −10 MHz, and from about 10 MHz to about 20 MHz), resulting in channel leakage, interference, and violation of some limitations applied to devise in some wireless communications. In such examples, the AP may apply some filtering, resulting in the filtered waveform 706, which both experiences a relatively flat spectrum across the full 20 MHz channel, and satisfies the spectral mask 702. In some examples, because of the flat spectrum across the channel, the AP may be able to transmit the wireless signaling (such as, via the filtered waveform 706) at a relatively high transmit power (such as, which would not be likely for the AP due to the spectral mask 702 without the flat spectrum and high PSD across the 20 MHz channel, or would not be possible for the AP if the AP were using a small quantity of populated tones for a small symbol duration spreading waveform). For example, the AP may be able to transmit the filtered waveform 706 at a transmit power of about 20 dBM (such as, in the case of a 20 dBM power limit applied as a threshold transmit power level for the spectral density threshold of 10). Such high transmit power (such as, equal to or close to a threshold transmit power across a channel) may result in increased reception and reliability of wireless communications at a STA, especially a low power device such as a backscatter device or a non-backscatter device.

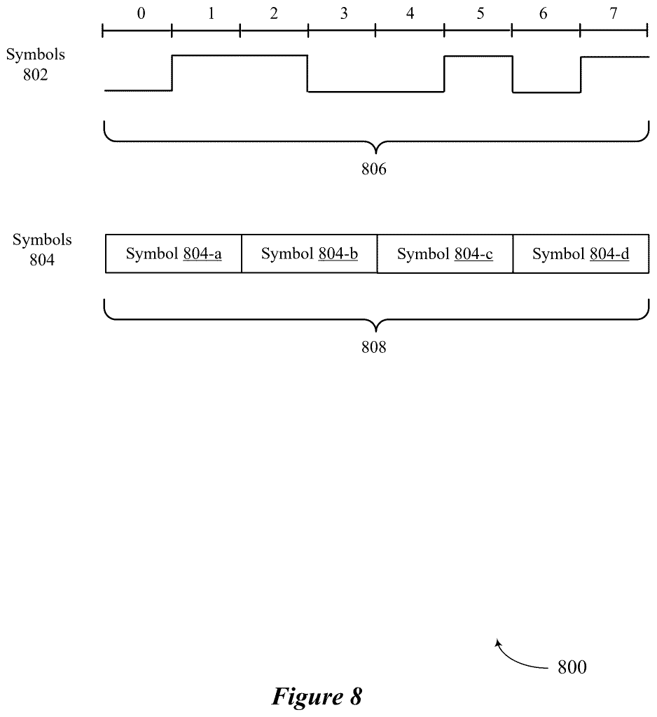

FIG. 8 shows an example of a waveform diagram 800 that supports ambient power downlink bandwidth control. The waveform diagram 800 may implement, or be implemented by, aspects of FIGS. 1-7. For example, a transmitting device (such as, an AP) and a receiving device (such as, a STA), which may be examples of corresponding devices described with reference to FIGS. 1-7, may perform wireless communications in accordance with the waveform diagram 800. In some examples, the transmitting device may be an example of an AP, or a reader device, among other examples. In some examples, the receiving device may be an example of a STA, a backscatter device, a non-backscatter device, or a tag, among other examples.

In some examples, as described in greater detail with reference to FIGS. 6 and 7, a transmitting device (such as, an AP) may generate a waveform in accordance with an OOK signal or OOK waveform (such as, the OOK waveform 806) modulated with a spreading waveform 808. In some examples, the AP may use a longer spreading waveform 808. For example, one such spreading waveform 808 may be constructed by the AP using an encoding sequence, such as a Barker sequence in a DSSS physical layer. For example, the symbols 804 may include one or more Barker sequences, such as 11-bit Barker sequences (such as, each of the symbol 804-a, the symbol 804-b, the symbol 804-c, and the symbol 804-d may be examples of a bit sequence such as an 11-bit Barker sequence). Each 11-bit Barker sequence may have a first symbol duration (such as, a 1 μs duration, spanning two 0.5 OOK symbols 802). The OOK waveform 806 (such as, made up of 0.5 μs symbols 802) may be modulated with the spreading waveform 808 (such as, made up of a concatenated sequence of 1 μs symbols 804). Thus, the second set of symbols 802 may have a different (such as, smaller) symbol duration from the first set of symbols 804. The symbol boundaries of the symbols 804 may be different from or may not align in time with the symbol boundaries of the symbols 802.

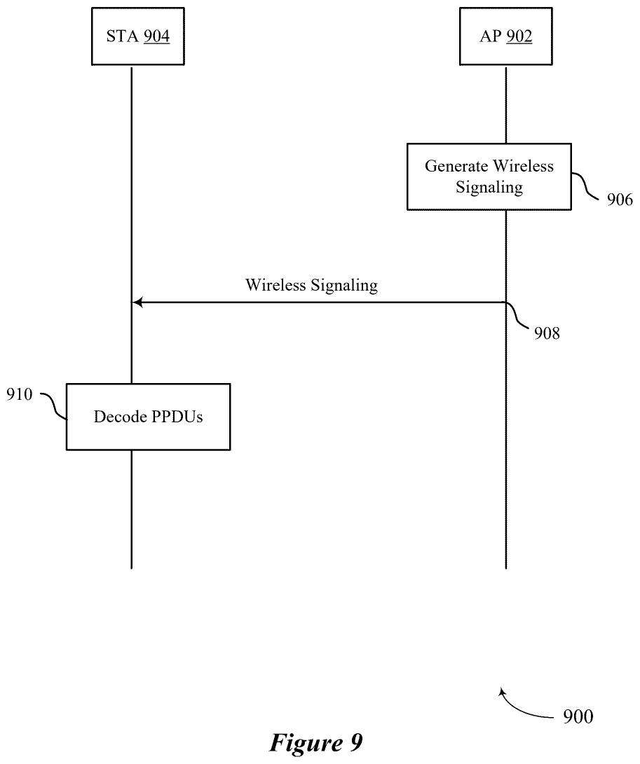

FIG. 9 shows an example of a process flow 900 that supports ambient power downlink bandwidth control. The process flow 900 may implement, or be implemented by, aspects of FIGS. 1-8. For example, the processing flow 900 includes an AP 902, and a STA 904, which may be examples of corresponding transmitting and receiving devices described with reference to FIGS. 1-8. In some examples, the AP 902 may be an example of an AP 102, a transmitting device, or a reader device, among other examples. In some examples, the STA 904 may be an example of a STA 104, a backscatter device, a non-backscatter device, or a tag, among other examples.

At 906, the AP 902 may generate downlink wireless signaling (such as, one or more PPDUs) for transmission to the STA 904. For example, the AP 902 may generate a spreading waveform including a sequence of concatenated symbols of a first duration (such as, OFDM symbols, Barker sequence symbols, or the like, as described in greater detail with reference to FIGS. 6-8). The AP 902 also may generate an OOK waveform (such as, a zero-mean OOK waveform) including a set of symbols of a second duration (such as, OOK symbols, such as 0.5 μs symbols) that is different than the first duration. The AP 902 may modulate the OOK waveform with the spreading waveform. In some examples, one or more symbol boundaries of at least a portion of the sequence of concatenated symbols of the first duration may not align in time with one or more symbol boundaries of at least a portion of the set of symbols of the second duration. For example, one or more standards documents may not require that the symbol boundaries of the OOK waveform and the spreading waveform align in time, or that the symbol durations be the same, or both. In some examples, the AP 902 may randomly populate a subset of tones of a set of tones corresponding to an FFT, and may concatenate the subset of populated tones into the spreading waveform.

The sequence of concatenated symbols of the spreading waveform may include a sequence of OFDM symbols (such as, as described with reference to FIG. 6), or a set of Barker sequence symbols (such as, as described with reference to FIG. 8). In some examples, the sequence of concatenated symbols of the spreading waveform may include LTF symbols, data symbols, BPSK keying symbols, QPSK symbols, or any combination thereof. In some examples, the set of symbols of the OOK waveform may include Manchester encoding OOK symbols. In some examples, the AP 902 may apply some filtering to ensure that the generated waveform (such as, a filtered waveform) satisfies a spectral mask.

The AP 902 may apply the waveform (such as, the spreading waveform, or the spreading waveform modulated by the OOK waveform) to a downlink rate less than or equal to a first downlink data rate (250 kbs/s), a second downlink data rate (such as, 1 Mb/s), or to both data rates.

At 908, the AP 902 may transmit the wireless signaling including one or more PPDUs via a wireless channel (such as, a 20 MHz channel) based on the generation at 906. The STA 904 may monitor for the one or more PPDUs, and may receive the downlink wireless signaling including the spreading waveform and the OOK waveform, where the OOK waveform is modulated with the spreading waveform as described herein.

In some examples, as described in greater detail with reference to FIG. 7, a PSD of the wireless signaling transmitted at 908 may not exceed a PSD threshold across the wireless channel, and the PSD may fall within a threshold range across at least a portion of the channel (such as, the PSD may be relatively flat across the channel, resulting in a relatively flat spectrum). The PSD may satisfy a spectral mask (such as, a DSSS spectral mask, an OFDM spectral mask, or the like).

At 910, the STA 904 may decode at least a first PPDU of the downlink wireless signaling in accordance with the OOK waveform modulated with the spreading waveform.

In some examples, techniques described herein may be utilized in part, or in combination with other techniques. For example, the AP 902, may generate the wireless signaling using short OFDM symbols (such as, using an FFT size of 10 for 10 populated tones to fit a 0.5 μs symbol duration). In some examples, the Barker codes described with reference to FIG. 8 may be short enough to fit in a smaller symbol duration (such as, 0.5 μs symbol duration).

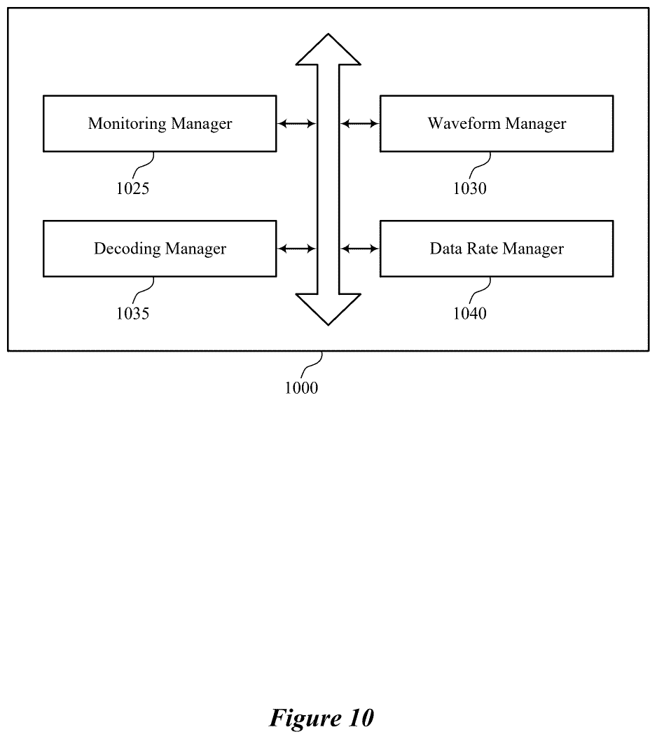

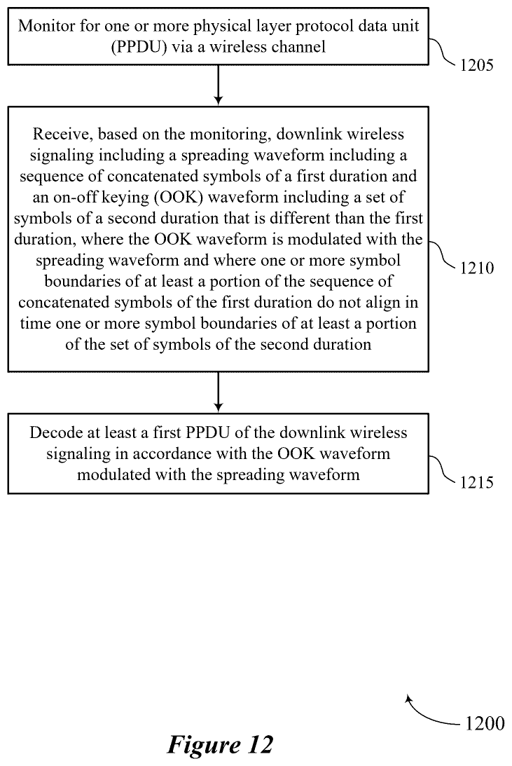

FIG. 10 shows a block diagram of an example wireless communication device 1000 that supports ambient power downlink bandwidth control. In some examples, the wireless communication device 1000 is configured to perform the process 1200 described with reference to FIG. 12. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in a STA, such as the STA 104 described with reference to FIG. 1. In some other examples, the wireless communication device 1000 can be a STA that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes a user interface (UI) (such as a touchscreen or keypad) and a display, which may be integrated with the UI to form a touchscreen display that is coupled with the processing system. In some examples, the wireless communication device 1000 may further include one or more sensors such as, for example, one or more inertial sensors, accelerometers, temperature sensors, pressure sensors, or altitude sensors, that are coupled with the processing system.

The wireless communication device 1000 includes a monitoring manager 1025, a waveform manager 1030, a decoding manager 1035, and a data rate manager 1040. Portions of one or more of the monitoring manager 1025, the waveform manager 1030, the decoding manager 1035, and the data rate manager 1040 may be implemented at least in part in hardware or firmware. For example, one or more of the monitoring manager 1025, the waveform manager 1030, the decoding manager 1035, and the data rate manager 1040 may be implemented at least in part by at least a processor or a modem. In some examples, portions of one or more of the monitoring manager 1025, the waveform manager 1030, the decoding manager 1035, and the data rate manager 1040 may be implemented at least in part by a processor and software in the form of processor-executable code stored in memory.

The wireless communication device 1000 may support wireless communications in accordance with examples as disclosed herein. The monitoring manager 1025 is configurable or configured to monitor for one or more physical layer protocol data unit (PPDU) via a wireless channel. The waveform manager 1030 is configurable or configured to receive, based on the monitoring, downlink wireless signaling including a spreading waveform including a sequence of concatenated symbols of a first duration and an on-off keying (OOK) waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration. The decoding manager 1035 is configurable or configured to decode at least a first PPDU of the downlink wireless signaling in accordance with the OOK waveform modulated with the spreading waveform.

In some examples, the sequence of concatenated symbols includes a sequence of orthogonal frequency domain modulation symbols, or a set of Barker sequence symbols.

In some examples, the sequence of concatenated symbols includes a long training field symbol, a random binary phase shift keying symbol, a quadrature phase shift keying symbol, or any combination thereof.

In some examples, the set of symbols of the OOK waveform include Manchester encoding OOK symbols.

In some examples, a power spectral density does not exceed a power spectral density threshold across the wireless channel and the power spectral density falls within a threshold range across at least a portion of the wireless channel.

In some examples, the power spectral density satisfies a spectral mask for the wireless channel.

In some examples, a filtering is applied to the wireless signaling to satisfy the spectral mask.

In some examples, a subset of tones of a set of multiple tones are randomly populated, the subset of tones corresponding to a multi-point Fast Fourier Transform.

In some examples, the STA includes a backscatter device, and the data rate manager 1040 is configurable or configured to apply the spreading waveform including the sequence of concatenated symbols of the first duration to downlink rate less than or equal to 250 kilobits per second.

In some examples, the STA includes a non-backscatter device, and the data rate manager 1040 is configurable or configured to apply the spreading waveform including the sequence of concatenated symbols of the first duration to downlink rate less than or equal to one megabit per second.

In some examples, the OOK waveform has a zero-mean value.

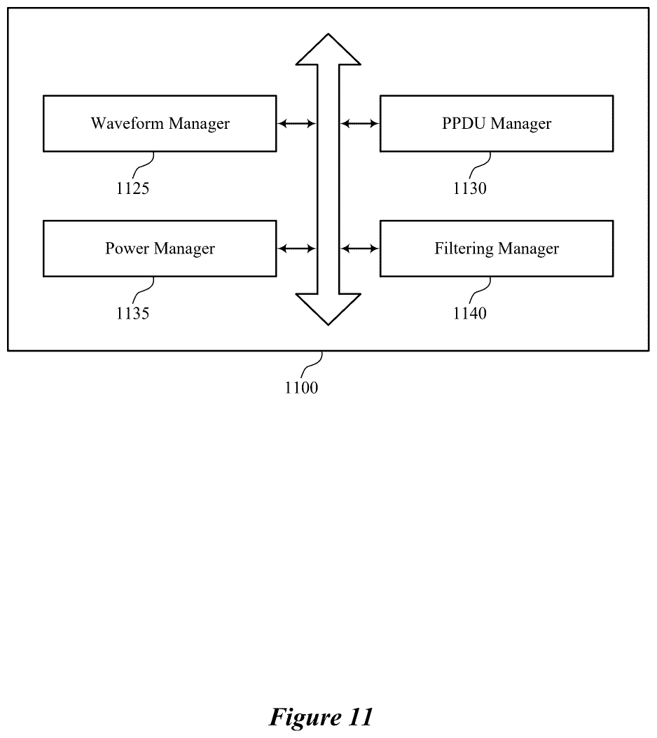

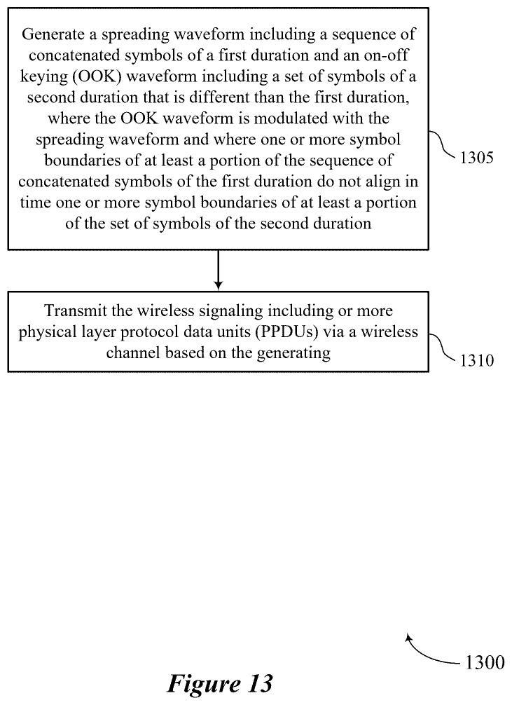

FIG. 11 shows a block diagram of an example wireless communication device 1100 that supports ambient power downlink bandwidth control. In some examples, the wireless communication device 1100 is configured to perform the process 1300 described with reference to FIG. 13. The wireless communication device 1100 may include one or more chips, SoCs, chipsets, packages, components or devices that individually or collectively constitute or include a processing system. The processing system may interface with other components of the wireless communication device 1100, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1100 may transmit the information output from the chip. In such an example, the second interface may refer to an interface between the processing system of the chip and a reception component, such that the wireless communication device 1100 may receive information that is then passed to the processing system. In some such examples, the first interface also may obtain information, such as from the transmission component, and the second interface also may output information, such as to the reception component.

The processing system of the wireless communication device 1100 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1100 can be configurable or configured for use in an AP, such as the AP 102 described with reference to FIG. 1. In some other examples, the wireless communication device 1100 can be an AP that includes such a processing system and other components including multiple antennas. The wireless communication device 1100 is capable of transmitting and receiving wireless communications in the form of, for example, wireless packets. For example, the wireless communication device 1100 can be configurable or configured to transmit and receive packets in the form of physical layer PPDUs and MPDUs conforming to one or more of the IEEE 802.11 family of wireless communication protocol standards. In some other examples, the wireless communication device 1100 can be configurable or configured to transmit and receive signals and communications conforming to one or more 3GPP specifications including those for 5G NR or 6G. In some examples, the wireless communication device 1100 also includes or can be coupled with one or more application processors which may be further coupled with one or more other memories. In some examples, the wireless communication device 1100 further includes at least one external network interface coupled with the processing system that enables communication with a core network or backhaul network that enables the wireless communication device 1100 to gain access to external networks including the Internet.

The wireless communication device 1100 includes a waveform manager 1125, a PPDU manager 1130, a power manager 1135, and a filtering manager 1140. Portions of one or more of the waveform manager 1125, the PPDU manager 1130, the power manager 1135, and the filtering manager 1140 may be implemented at least in part in hardware or firmware. For example, one or more of the waveform manager 1125, the PPDU manager 1130, the power manager 1135, and the filtering manager 1140 may be implemented at least in part by at least a processor or a modem. In some examples, portions of one or more of the waveform manager 1125, the PPDU manager 1130, the power manager 1135, and the filtering manager 1140 may be implemented at least in part by a processor and software in the form of processor-executable code stored in memory.

The wireless communication device 1100 may support wireless communications in accordance with examples as disclosed herein. The waveform manager 1125 is configurable or configured to generate a spreading waveform including a sequence of concatenated symbols of a first duration and an on-off keying (OOK) waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration. The PPDU manager 1130 is configurable or configured to transmit the wireless signaling including or more physical layer protocol data units (PPDUs) via a wireless channel based on the generating.

In some examples, the sequence of concatenated symbols includes a sequence of orthogonal frequency domain modulation symbols, or a set of Barker sequence symbols.

In some examples, the sequence of concatenated symbols includes a long training field symbol, a random binary phase shift keying symbol, a quadrature phase shift keying symbol, or any combination thereof.

In some examples, the set of symbols of the OOK waveform include Manchester encoding OOK symbols.

In some examples, to support transmitting the wireless signaling, the power manager 1135 is configurable or configured to transmit the wireless signaling according to a transmit power where a power spectral density does not exceed a power spectral density threshold across the wireless channel and the power spectral density falls within a threshold range across at least a portion of the wireless channel.

In some examples, the power spectral density satisfies a spectral mask for the wireless channel.

In some examples, the filtering manager 1140 is configurable or configured to apply a filter to the wireless signaling to satisfy the spectral mask.

In some examples, the waveform manager 1125 is configurable or configured to randomly populate a subset of tones of a set of multiple tones corresponding to a multi-point Fast Fourier Transform. In some examples, the waveform manager 1125 is configurable or configured to concatenate the subset of populated tones, where the spreading waveform is based on the concatenating.

In some examples, the waveform manager 1125 is configurable or configured to apply the spreading waveform including the sequence of concatenated symbols of the first duration to downlink rate less than or equal to 250 kilobits per second.

In some examples, the waveform manager 1125 is configurable or configured to apply the spreading waveform including the sequence of concatenated symbols of the first duration to downlink rate less than or equal to one megabit per second.

In some examples, the OOK waveform has a zero-mean value.

FIG. 12 shows a flowchart illustrating an example process 1200 performable by or at a STA that supports ambient power downlink bandwidth control. The operations of the process 1200 may be implemented by a STA or its components as described herein. For example, the process 1200 may be performed by a wireless communication device, such as the wireless communication device 1000 described with reference to FIG. 10, operating as or within a wireless STA. In some examples, the process 1200 may be performed by a wireless STA, such as one of the STAs 104 described with reference to FIG. 1.

In some examples, in 1205, the STA may monitor for one or more physical layer protocol data unit (PPDU) via a wireless channel. The operations of 1205 may be performed in accordance with examples as disclosed herein. In some implementations, aspects of the operations of 1205 may be performed by a monitoring manager 1025 as described with reference to FIG. 10.

In some examples, in 1210, the STA may receive, based on the monitoring, downlink wireless signaling including a spreading waveform including a sequence of concatenated symbols of a first duration and an on-off keying (OOK) waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration. The operations of 1210 may be performed in accordance with examples as disclosed herein. In some implementations, aspects of the operations of 1210 may be performed by a waveform manager 1030 as described with reference to FIG. 10.

In some examples, in 1215, the STA may decode at least a first PPDU of the downlink wireless signaling in accordance with the OOK waveform modulated with the spreading waveform. The operations of 1215 may be performed in accordance with examples as disclosed herein. In some implementations, aspects of the operations of 1215 may be performed by a decoding manager 1035 as described with reference to FIG. 10.

FIG. 13 shows a flowchart illustrating an example process 1300 performable by or at an AP that supports ambient power downlink bandwidth control. The operations of the process 1300 may be implemented by an AP or its components as described herein. For example, the process 1300 may be performed by a wireless communication device, such as the wireless communication device 1100 described with reference to FIG. 11, operating as or within a wireless AP. In some examples, the process 1300 may be performed by a wireless AP, such as one of the APs 102 described with reference to FIG. 1.

In some examples, in 1305, the AP may generate a spreading waveform including a sequence of concatenated symbols of a first duration and an on-off keying (OOK) waveform including a set of symbols of a second duration that is different than the first duration, where the OOK waveform is modulated with the spreading waveform and where one or more symbol boundaries of at least a portion of the sequence of concatenated symbols of the first duration do not align in time one or more symbol boundaries of at least a portion of the set of symbols of the second duration. The operations of 1305 may be performed in accordance with examples as disclosed herein. In some implementations, aspects of the operations of 1305 may be performed by a waveform manager 1125 as described with reference to FIG. 11.

In some examples, in 1310, the AP may transmit the wireless signaling including or more physical layer protocol data units (PPDUs) via a wireless channel based on the generating. The operations of 1310 may be performed in accordance with examples as disclosed herein. In some implementations, aspects of the operations of 1310 may be performed by a PPDU manager 1130 as described with reference to FIG. 11.

### Implementation Examples are Described in the Following Numbered Clauses

The following provides an overview of aspects of the present disclosure:
Aspect 1: A method for wireless communications at a STA, comprising: monitoring for one or more PPDU via a wireless channel; receiving, based at least in part on the monitoring, downlink wireless signaling comprising a spreading waveform comprising a sequence of concatenated symbols of a first duration and an OOOK waveform comprising a set of symbols of a second duration that is different than the first duration, wherein the OOK waveform is modulated with the spreading waveform and wherein one or more symbol boundaries of at least a portion of the sequence of concatenated symbols of the first duration do not align in time one or more symbol boundaries of at least a portion of the set of symbols of the second duration; and decoding at least a first PPDU of the downlink wireless signaling in accordance with the OOK waveform modulated with the spreading waveform.
Aspect 2: The method of aspect 1, wherein the sequence of concatenated symbols comprises a sequence of orthogonal frequency domain modulation symbols, or a set of Barker sequence symbols.
Aspect 3: The method of any of aspects 1 through 2, wherein the sequence of concatenated symbols comprises a long training field symbol, a random binary phase shift keying symbol, a quadrature phase shift keying symbol, or any combination thereof.
Aspect 4: The method of any of aspects 1 through 3, wherein the set of symbols of the OOK waveform comprise Manchester encoding OOK symbols.
Aspect 5: The method of any of aspects 1 through 4, wherein a power spectral density does not exceed a power spectral density threshold across the wireless channel and the power spectral density falls within a threshold range across at least a portion of the wireless channel.
Aspect 6: The method of aspect 5, wherein the power spectral density satisfies a spectral mask for the wireless channel.
Aspect 7: The method of aspect 6, wherein a filtering is applied to the wireless signaling to satisfy the spectral mask.
Aspect 8: The method of any of aspects 1 through 7, wherein a subset of tones of a plurality of tones are randomly populated, the subset of tones corresponding to a multi-point Fast Fourier Transform.
Aspect 9: The method of any of aspects 1 through 8, wherein the STA comprises a backscatter device, the method further comprising: applying the spreading waveform comprising the sequence of concatenated symbols of the first duration to downlink rate less than or equal to 250 kilobits per second.
Aspect 10: The method of any of aspects 1 through 9, wherein the STA comprises a non-backscatter device, the method further comprising: applying the spreading waveform comprising the sequence of concatenated symbols of the first duration to downlink rate less than or equal to one megabit per second.
Aspect 11: The method of any of aspects 1 through 10, wherein the OOK waveform has a zero-mean value.
Aspect 12: A method for wireless communications at an AP, comprising: generating a spreading waveform comprising a sequence of concatenated symbols of a first duration and an OOK waveform comprising a set of symbols of a second duration that is different than the first duration, wherein the OOK waveform is modulated with the spreading waveform and wherein one or more symbol boundaries of at least a portion of the sequence of concatenated symbols of the first duration do not align in time one or more symbol boundaries of at least a portion of the set of symbols of the second duration; and transmitting the wireless signaling comprising or more PPDUs via a wireless channel based at least in part on the generating.
Aspect 13: The method of aspect 12, wherein the sequence of concatenated symbols comprises a sequence of orthogonal frequency domain modulation symbols, or a set of Barker sequence symbols.
Aspect 14: The method of any of aspects 12 through 13, wherein the sequence of concatenated symbols comprises a long training field symbol, a random binary phase shift keying symbol, a quadrature phase shift keying symbol, or any combination thereof.
Aspect 15: The method of any of aspects 12 through 14, wherein the set of symbols of the OOK waveform comprise Manchester encoding OOK symbols.
Aspect 16: The method of any of aspects 12 through 15, wherein transmitting the wireless signaling further comprises: transmitting the wireless signaling according to a transmit power wherein a power spectral density does not exceed a power spectral density threshold across the wireless channel and the power spectral density falls within a threshold range across at least a portion of the wireless channel.
Aspect 17: The method of aspect 16, wherein the power spectral density satisfies a spectral mask for the wireless channel.
Aspect 18: The method of aspect 17, further comprising: applying a filter to the wireless signaling to satisfy the spectral mask.
Aspect 19: The method of any of aspects 12 through 18, further comprising: randomly populating a subset of tones of a plurality of tones corresponding to a multi-point Fast Fourier Transform; and concatenating the subset of populated tones, wherein the spreading waveform is based at least in part on the concatenating.
Aspect 20: The method of any of aspects 12 through 19, further comprising: applying the spreading waveform comprising the sequence of concatenated symbols of the first duration to downlink rate less than or equal to 250 kilobits per second.
Aspect 21: The method of any of aspects 12 through 20, further comprising: applying the spreading waveform comprising the sequence of concatenated symbols of the first duration to downlink rate less than or equal to one megabit per second.
Aspect 22: The method of any of aspects 12 through 21, wherein the OOK waveform has a zero-mean value.
Aspect 23: A STA for wireless communications, comprising one or more memories storing processor-executable code, and one or more processors coupled with the one or more memories and individually or collectively operable to execute the code to cause the STA to perform a method of any of aspects 1 through 11.
Aspect 24: A STA for wireless communications, comprising at least one means for performing a method of any of aspects 1 through 11.
Aspect 25: A non-transitory computer-readable medium storing code for wireless communications, the code comprising instructions executable by one or more processors to perform a method of any of aspects 1 through 11.
Aspect 26: An AP for wireless communications, comprising one or more memories storing processor-executable code, and one or more processors coupled with the one or more memories and individually or collectively operable to execute the code to cause the AP to perform a method of any of aspects 12 through 22.
Aspect 27: An AP for wireless communications, comprising at least one means for performing a method of any of aspects 12 through 22.
Aspect 28: A non-transitory computer-readable medium storing code for wireless communications, the code comprising instructions executable by one or more processors to perform a method of any of aspects 12 through 22.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A station (STA), comprising:
a processing system that includes processor circuitry and memory circuitry that stores code, the processing system configured to cause the STA to:
monitor for one or more physical layer protocol data unit (PPDU) via a wireless channel;
receive, based at least in part on the monitoring, downlink wireless signaling comprising a spreading waveform comprising a sequence of concatenated symbols of a first duration and an on-off keying (OOK) waveform comprising a set of symbols of a second duration that is different than the first duration, wherein the OOK waveform is modulated with the spreading waveform and wherein one or more symbol boundaries of at least a portion of the sequence of concatenated symbols of the first duration do not align in time one or more symbol boundaries of at least a portion of the set of symbols of the second duration; and
decode at least a first PPDU of the downlink wireless signaling in accordance with the OOK waveform modulated with the spreading waveform.

2. The STA of claim 1, wherein the sequence of concatenated symbols comprises a sequence of orthogonal frequency domain modulation symbols, or a set of Barker sequence symbols.

3. The STA of claim 1, wherein the sequence of concatenated symbols comprises a long training field symbol, a random binary phase shift keying symbol, a quadrature phase shift keying symbol, or any combination thereof.

4. The STA of claim 1, wherein:
the set of symbols of the OOK waveform comprise Manchester encoding OOK symbols.

5. The STA of claim 1, wherein a power spectral density does not exceed a power spectral density threshold across the wireless channel and the power spectral density falls within a threshold range across at least a portion of the wireless channel.

6. The STA of claim 5, wherein:
the power spectral density satisfies a spectral mask for the wireless channel.

7. The STA of claim 6, wherein a filtering is applied to the wireless signaling to satisfy the spectral mask.

8. The STA of claim 1, wherein a subset of tones of a plurality of tones are randomly populated, the subset of tones corresponding to a multi-point Fast Fourier Transform.

9. The STA of claim 1, wherein the STA comprises a backscatter device, and the processing system is further configured to cause the STA to:
apply the spreading waveform comprising the sequence of concatenated symbols of the first duration to downlink rate less than or equal to 250 kilobits per second.

10. The STA of claim 1, wherein the STA comprises a non-backscatter device, and the processing system is further configured to cause the STA to:
apply the spreading waveform comprising the sequence of concatenated symbols of the first duration to downlink rate less than or equal to one megabit per second.

11. An access point (AP), comprising:
one or more memories storing processor-executable code; and
one or more processors coupled with the one or more memories and individually or collectively operable to execute the code to cause the AP to:
generate a spreading waveform comprising a sequence of concatenated symbols of a first duration and an on-off keying (OOK) waveform comprising a set of symbols of a second duration that is different than the first duration, wherein the OOK waveform is modulated with the spreading waveform and wherein one or more symbol boundaries of at least a portion of the sequence of concatenated symbols of the first duration do not align in time one or more symbol boundaries of at least a portion of the set of symbols of the second duration; and
transmit wireless signaling comprising or more physical layer protocol data units (PPDUs) via a wireless channel based at least in part on the generating.

12. The AP of claim 11, wherein the sequence of concatenated symbols comprises a sequence of orthogonal frequency domain modulation symbols, or a set of Barker sequence symbols.

13. The AP of claim 11, wherein the sequence of concatenated symbols comprises a long training field symbol, a random binary phase shift keying symbol, a quadrature phase shift keying symbol, or any combination thereof.

14. The AP of claim 11, wherein:
the set of symbols of the OOK waveform comprise Manchester encoding OOK symbols.

15. The AP of claim 11, wherein, to transmit the wireless signaling, the one or more processors are individually or collectively further operable to execute the code to cause the AP to:
transmit the wireless signaling according to a transmit power wherein a power spectral density does not exceed a power spectral density threshold across the wireless channel and the power spectral density falls within a threshold range across at least a portion of the wireless channel.

16. The AP of claim 15, wherein:
the power spectral density satisfies a spectral mask for the wireless channel, and wherein the one or more processors are individually or collectively further operable to execute the code to cause the AP to apply a filter to the wireless signaling to satisfy the spectral mask.

17. The AP of claim 11, wherein the one or more processors are individually or collectively further operable to execute the code to cause the AP to:
randomly populate a subset of tones of a plurality of tones corresponding to a multi-point Fast Fourier Transform; and
concatenate the subset of populated tones, wherein the spreading waveform is based at least in part on the concatenating.

18. The AP of claim 11, wherein the one or more processors are individually or collectively further operable to execute the code to cause the AP to:
apply the spreading waveform comprising the sequence of concatenated symbols of the first duration to downlink rate less than or equal to 250 kilobits per second.

19. The AP of claim 11, wherein the one or more processors are individually or collectively further operable to execute the code to cause the AP to:
apply the spreading waveform comprising the sequence of concatenated symbols of the first duration to downlink rate less than or equal to one megabit per second.

20. A method for wireless communications at a station (STA), comprising:
monitoring for one or more physical layer protocol data unit (PPDU) via a wireless channel;
receiving, based at least in part on the monitoring, downlink wireless signaling comprising a spreading waveform comprising a sequence of concatenated symbols of a first duration and an on-off keying (OOK) waveform comprising a set of symbols of a second duration that is different than the first duration, wherein the OOK waveform is modulated with the spreading waveform and wherein one or more symbol boundaries of at least a portion of the sequence of concatenated symbols of the first duration do not align in time one or more symbol boundaries of at least a portion of the set of symbols of the second duration; and
decoding at least a first PPDU of the downlink wireless signaling in accordance with the OOK waveform modulated with the spreading waveform.
